(19) United States
(12) Patent Application Publication
(10) Pub. No.: US 2016/0065383 A1
(43) Pub. Date: Mar. 3, 2016

(54) HOME CONTROL GATEWAY AND GATEWAY CONNECTION METHOD THEREOF

(71) Applicant: proeasy network solutions co., LTD., Hsinchu County (TW)

(72) Inventor: Hsing-Hung Lu, Hsinchu County (TW)

(21) Appl. No.: 14/558,727

(22) Filed: Dec. 3, 2014

(30) Foreign Application Priority Data
Aug. 27, 2014 (TW) 103129511

(51) Int. Cl. H04L 12/28; G05B 15/02; G06N 99/00; H04M 3/42

(52) U.S. Cl. CPC H04L 12/2834; H04M 3/42068; G05B 15/02; G06N 99/005; H04W 84/042

(57) ABSTRACT

A home control gateway and a gateway connection method for users to perform remote home control by using the mobile communication device are provided. The gateway connection method includes: during the period of continually receiving the learning signal after the learning signal and the reset signal are simultaneously received, receiving a calling signal from a mobile communication device through a mobile phone network; identifying a phone number of the mobile communication device according to the calling signal; storing the phone number of the mobile communication device into a storage circuit; generating an identity code according to the phone number; transferring a short message containing the identity code to the mobile communication device through the mobile phone network; and permitting the mobile communication device to access an operating interface through a local area network by using a class C network uniform resource locator containing the identity code.

### CROSS-REFERENCE TO RELATED APPLICATION

This application claims the priority benefit of Taiwan application serial no. 103129511, filed on Aug. 27, 2014. The entirety of the above-mentioned patent application is hereby incorporated by reference herein and made a part of this specification.

### BACKGROUND OF THE INVENTION

1. Field of the Invention

The invention relates a home control technology, and more particularly, relates to a home control gateway and a gateway control method thereof.

2. Description of Related Art

Since the most recent half-century, the computer field has been developed rapidly. With developments in the computer field, various automation equipments (such as washing machines, dishwashers, sweeping robots, etc.) are widely applied in daily lives. Further, with changes in household population structure and work style, manpower dedicated to general affairs of household has also been gradually replaced by machines. Integration solutions for managing and controlling various household appliances or equipments (e.g., lightings, televisions, security systems, air conditioners, audiovisual sound systems, etc.) are constantly re-innovated. Thus, nouns like “Smart home”, “Digital Home”, “Electronic Home”, “Home Automation” are introduced accordingly.

A home automation control system combines uses of the automated equipments together with computer software technology and applications to integrate household equipments (e.g., televisions, electric rice cooker, air conditioners, refrigerators, gas switches, alarm systems, security systems, surveillance systems, etc.) in order to improve home comfort and home safety. The home automation control system generally includes a control system and a control host, such that users may issue control commands through the control system in order to drive various equipments through the control system. In addition, various wireless communication transmission technologies (e.g., GPRS, WiFi, WiMAX, 3G or 4G) can achieve greater flexibility and convenience by using the function of Internet connectivity in mobile equipments (e.g., mobile phones or notebook computers) to connect the Internet in order to remotely control various household equipments, enable a security mechanism, or monitor home event even if the users are in business trip, on vacation or traveling.

However, the remote control provides not only the flexibility and convenience but also security issues such as confirmation on user identity. Generally, the control host may assign a control right to a user and thereby allow the user to achieve the purpose of the remote control only after the user identity is confirmed through an authentication mechanism. A common method for the authentication mechanism includes the following. A web address is provided by a remote home control system host, so that the user may enter a user name and a password correctly through the web address in order to obtain the control right of the remote home control system host after the authentication is passed. However, it is quite often that the user may forget the user name and the password, or the user name and the password may possibly be stolen. Therefore, the invention aims to provide a convenient, secure, simple and easy method for the user to conveniently and securely perform the remote control.

### SUMMARY OF THE INVENTION

The invention is directed to a home control gateway and a gateway connection method thereof, and capable of allowing a user to use the home control gateway to automatically record a phone number of the user and obtain an identity code through a short message. Accordingly, a mobile communication device of the user can access an operating interface of the home control gateway by using a class C network uniform resource locator containing the identity code for establishing connection channels with the home control gateway to perform the remote home control more securely.

An exemplary embodiment of the invention provides a home control gateway, which includes a microprocessor unit, a storage circuit, a gateway management module, a storage circuit, a first communication circuit, a second communication circuit, a learning button and a reset button. The gateway management module is coupled to the microprocessor unit, and provides an operating interface. The storage circuit is coupled to the microprocessor unit. The first communication circuit is coupled to the microprocessor unit, and configured to connect to a mobile phone network. The second communication circuit is coupled to the microprocessor unit, and configured to connect to a local area network. The learning button is coupled to the gateway management module. The reset button is coupled to the gateway management module. The gateway management module receives a reset signal when the reset button is enabled, and the gateway management module receives a learning signal when the learning button is enabled. In addition, when the first communication circuit receives a first calling signal from the mobile communication device through the mobile phone network during a period of continually receiving the learning signal after the learning signal and the reset signal are simultaneously received, the gateway management module identifies the phone number of the mobile communication device according to the first calling signal and stores the phone number corresponding to the mobile communication device into the storage circuit. Furthermore, the gateway management module generates an identity code according to the phone number. Moreover, the first communication circuit transfers a short message containing the identity code to the mobile communication device through the mobile phone network. Thereafter, the gateway management module permits the mobile communication device to access an operating interface through a local area network by using a class C network uniform resource locator containing the identity code.

In an exemplary embodiment of the invention, the first communication device is further configured to receive a second calling signal from the mobile communication device through the mobile phone network. The gateway management module identifies the phone number of the mobile communication device according to the second calling signal and determines whether the phone number of the mobile communication device exists in the storage circuit. The gateway management module activates a counter corresponding to the phone number of the mobile communication device when the phone number of the mobile communication device exists in the storage circuit.

In an exemplary embodiment of the invention, the gateway management module stops and resets the counter corresponding to the phone number of the mobile communication device when a count value of the counter corresponding to the phone number of the mobile communication device is greater than a counter preset threshold.

In an exemplary embodiment of the invention, the gateway management module permits the mobile communication device to access the operating interface through the local area network by using the class C network uniform resource locator only when the counter corresponding to the phone number of the mobile communication device is activated and the count value of the counter corresponding to the phone number of the mobile communication device is not greater than the counter preset threshold.

In an exemplary embodiment of the invention, the gateway management module has a mapping table. Specifically, the mapping table includes a plurality of characters or symbols, and the characters and symbols are corresponding to a plurality of numbers. The gateway management module generates the identity code by searching each of numbers in the phone number of the mobile communication device for the corresponding characters or symbols according to the mapping table.

An exemplary embodiment of the invention provides a gateway connection method executed by a home control gateway, and the home control gateway provides an operating interface. The gateway connection method includes: connecting to a mobile phone network; connecting to a local area network; receiving a learning signal from the learning button; receiving a reset signal from the reset button. The gateway connection method further includes: when a first calling signal from a mobile communication device is received through the mobile phone network during the period of continually receiving the learning signal after the learning signal and the reset signal are simultaneously received, identifying a phone number of the mobile communication device according to the first calling signal, and storing the phone number corresponding to the mobile communication device into a storage circuit. The gateway connection method further includes: generating an identity code according to the phone number; transferring a short message containing the identity code to the mobile communication device through the mobile phone network; and permitting the mobile communication device to access an operating interface through a local area network by using a class C network uniform resource locator containing the identity code.

In an exemplary embodiment of the invention, the gateway connection method further includes: receiving a second calling signal from the mobile communication device through the mobile phone network; identifying the phone number of the mobile communication device according to the second calling signal and determining whether the phone number of the mobile communication device exists in the storage circuit; and activating a counter corresponding to the phone number of the mobile communication device when the phone number of the mobile communication device exists in the storage circuit.

In an exemplary embodiment of the invention, the gateway connection method further includes: stopping and resetting the counter corresponding to the phone number of the mobile communication device when a count value of the counter corresponding to the phone number of the mobile communication device is greater than a counter preset threshold.

In an exemplary embodiment of the invention, the gateway connection method further includes: wherein the gateway management module permits the mobile communication device to access the operating interface through the local area network by using the class C network uniform resource locator only when the counter corresponding to the phone number of the mobile communication device is activated and the count value of the counter corresponding to the phone number of the mobile communication device is not greater than the counter preset threshold.

In an exemplary embodiment of the invention, the home control gateway has a mapping table including a plurality of characters or symbols, and the characters and symbols are corresponding to a plurality of numbers. Further, the step of generating the identity code according to the phone number includes: generating the identity code by searching each of numbers in the phone number of the mobile communication device for the corresponding characters or symbols according to the mapping table.

Based on above, the home control gateway and the gateway connection method thereof according to the exemplary embodiments of the invention are provided. Among them, the machine is capable of automatically recording the phone numbers of the users and transferring the identity code corresponding to the phone number in the short message to the users by triggering a learning function of the gateway communication filter without additional man-machine interfaces. When the users intend to perform the remote home control, the users are only required to use the mobile communication devices of their own and the class C network uniform resource locator containing the identity code in order to connect to the home control gateway. As a result, the connection channels can be established between the mobile communication devices and the home control gateway for controlling the home equipment through the operating interface. Accordingly, the users are able to operate the household equipments in convenient, secure, simple and easy manners.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a remote home control according to an exemplary embodiment.

FIG. 2 is a block diagram illustrating a home control gateway according to an exemplary embodiment.

FIG. 3 is a flowchart illustrating a mapping table in the gateway control method according to an exemplary embodiment.

FIG. 4 is a flowchart illustrating a gateway connection method according to an exemplary embodiment.

FIG. 5A, FIG. 5B and FIG. 5C are flowcharts illustrating a gateway connection method according to another exemplary embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

With growth of the Internet technology, if steps of confirming the user identity can be further simplified and a more secure remote control method may be provided, an automation home control system may indeed be operated more conveniently and easily. The invention is developed based on the above concept.

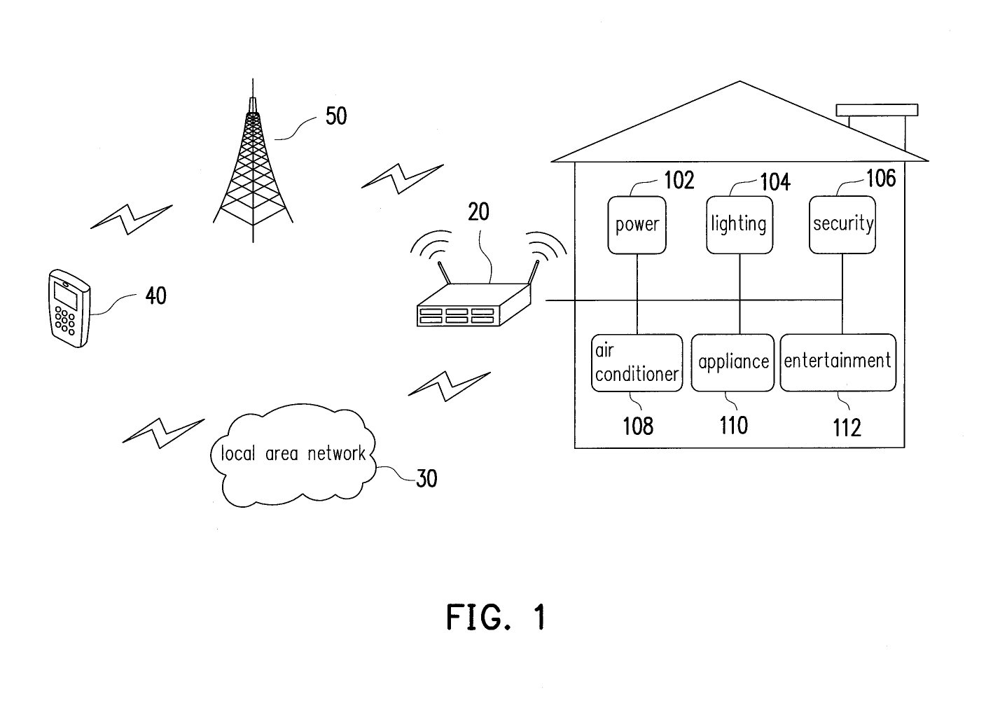

FIG. 1 is a schematic diagram illustrating a remote home control according to an exemplary embodiment.

Referring to FIG. 1, an environment of a remote home control usually includes household equipments, a home control gateway 20, a local area network 30, a mobile communication device 40 and a mobile phone network 50.

The household equipments include a power equipment 102, a lighting equipment 104, a security equipment 106, an air condition equipment 108, an appliance equipment 110, and an entertainment equipment 112. However, it should be noted that, the household equipments are not limited to the above, and the listed household equipments are not intended to limit the invention. For example, each of the power equipment 102, the lighting equipment 104, the security equipment 106, the air condition equipment 108, the appliance equipment 110, and the entertainment equipment 112 may include a control chip or a control circuit for receiving a control command from the home control gateway 20, and executing the corresponding functional operations according to the control command.

The home control gateway 20 provides an operating interface for the corresponding services. In an embodiment of the invention, this operating interface performs a remote control to the power equipment 102, the lighting equipment 104, the security equipment 106, the air condition equipment 108, the appliance equipment 110, and the entertainment equipment 112 through a web control interface or an application (APP). In addition, the home control gateway 20 has one or more communication channels, and a user may use the mobile communication device 40 to perform the remote control through communications with the home control gateway 20 via the communication channel(s).

The local area network 30 is a wireless communication network (Wi-Fi) established according to LAN protocol transmission standard, and the home control gateway 20 may communicate with other electronic devices with network conductivity through the local area network 30. For example, this LAN protocol transmission standard is 802.11 series constituted by Institute of Electrical and Electronics Engineers (IEEE). However, the invention is not limited thereto.

The mobile communication device 40 is a mobile communication equipment of the user, which includes Subscriber Identity Module Card (SIM Card). The mobile communication device 40 is, for example, a cell phone, a personal digital assistant (PDA) phone, a smart phone, and so on. However, the invention is not intended to limit types of the mobile communication device 40.

The mobile phone network 50 is a telecommunication service provided by a telecommunication service provider, such as Global System For Mobile Communications (GSM), Code Division Multiple Access (CDMA), Personal Handy-phone System, (PHS) and so on.

In the present exemplary embodiment, the mobile communication device 40 is capable of communicating with the home control gateway 20 through voice signals of the mobile phone network 50 or by ways of Short Message Service (SMS) or voice message. In addition, the home control gateway 20 may also receive a connection request from the mobile communication device 40 through the local area network 30. When the connection request of the mobile communication device 40 is permitted, the home control gateway 20 may provide the operating interface of the corresponding services, such that the user may perform the remote control to the power equipment 102, the lighting equipment 104, the security equipment 106, the air condition equipment 108, the appliance equipment 110, and the entertainment equipment 112.

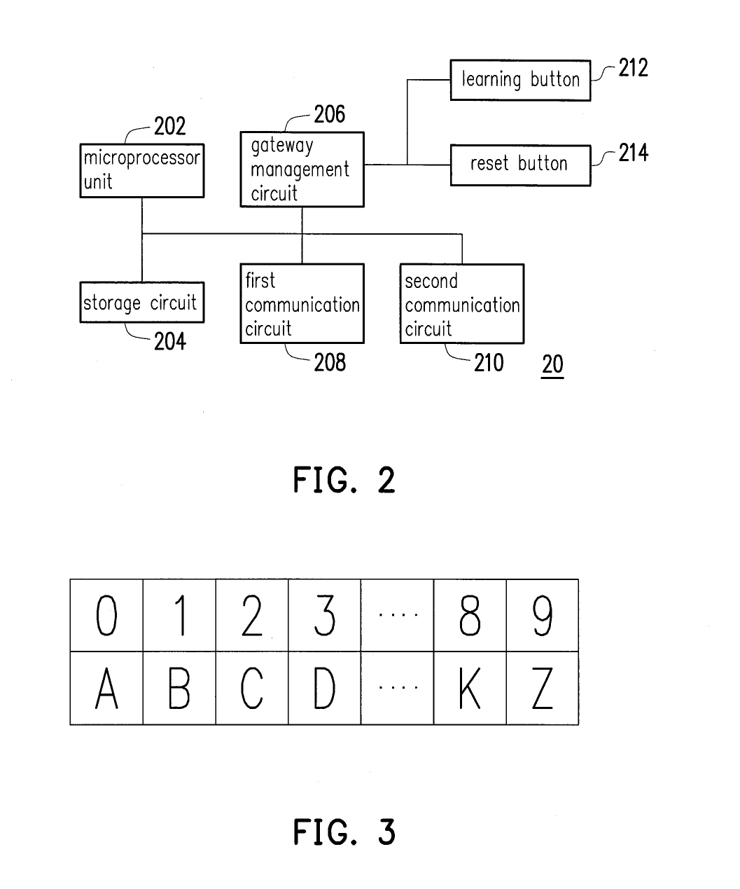

FIG. 2 is a block diagram illustrating a home control gateway according to an exemplary embodiment.

Referring to FIG. 2, the home control gateway 20 includes a microprocessor unit 202, a storage circuit 204, a gateway management module 206, a first communication circuit 208, a second communication circuit 210, a learning button 212 and a reset button 214.

The microprocessor unit 202 may be a hardware with computing capabilities (e.g., a chip set, a processor, etc.) which is configured to control overall operation of the home control gateway 20. In the present exemplary embodiment, the microprocessor unit 202 is, for example, a central processing unit (CPU) or other programmable microprocessors, a digital signal processor (DSP), a programmable controller, an application specific integrated circuits (ASIC), a programmable logic device (PLD) or other similar devices.

The storage circuit 204 is coupled to the microprocessor unit 202. The storage circuit 204 may be an embedded storage unit or an external storage unit. The embedded storage unit may be a random access memory (RAM), a read-only memory (ROM), a flash memory, a magnetic disk storage device, and so on. The external storage unit may be Compact Flash (CF) memory card, Secure Digital (SD) memory card, Micro SD memory card, Memory Stick (MS) memory card, and so on. Specifically, in the exemplary embodiments of the invention, the storage circuit 204 is configured to store a phone number of the mobile communication device and store one or more programs or applications, operating systems for controlling operation of the home control gateway 20.

The gateway management module 206 is coupled to the microprocessor unit 202, and configured to receive various signals, and identify and compare the phone number of the user. In another embodiment of the invention, the gateway management module 206 is implemented in a manner of circuitry, but the invention is not limited thereto. For example, functions of the gateway management module 206 may also be implemented in a manner of program codes stored in the storage circuit 204. Further, when the home control gateway 20 is powered on, the microprocessor unit 202 may run the program codes in order to execute the functions of the gateway management module 206. In addition, the gateway management module 206 also provides the operating interface. The home control gateway 20 also provides a class C network uniform resource locator (URL) (i.e., a web address) for accessing the operating interface. Particularly, the home control gateway 20 only permits the electronic device of the user to access the operating interface provided by the home control gateway 20 by using the class C network uniform resource locator containing the identity code. It should be noted that, the class C network herein refers to an IP (Internet Protocol) address of the home control gateway 20 assigned by the corresponding local area network 30. For instance, the address of this class C network is “192.168.1.1”. Therefore, the class C network uniform resource locator containing the identity code is, for example, “http://192.168.1.1/AZKKAKKAKK”. In the present exemplary embodiment, the operating interface is implemented in form of a web page, and the mobile communication device 40 uses a browser to open a service page through Wi-Fi connection with the web address provided by the home control gateway 20. In another embodiment of the invention, the operating interface may also be in form of the application (APP). Nevertheless, it should be understood that the invention is not limited thereto.

The first communication circuit 208 is coupled to the microprocessor unit 202 and operates by using a transmission standard or a protocol compatible with the mobile phone network 50. For example, the first communication circuit 208 is capable of transferring and receiving a short message or a voice signal through the mobile phone network 50.

The second communication circuit 210 is coupled to the microprocessor unit 202 and operates by using a transmission standard or a protocol compatible with the local area network 30 in order to transfer or receive packets through the local area network 30.

The learning button 212 is coupled to the gateway management module 206. In the present exemplary embodiment, when the learning button 212 is enabled, the gateway management module 206 receives a learning signal.

The reset button 214 is coupled to the gateway management module 206. In the present exemplary embodiment, when the reset button 214 is enabled, the gateway management module 206 receives a reset signal.

In an exemplary embodiment of the invention, before performing the remote home control operation through the home control gateway 20, the user must store the phone number of the user and obtain the identity code in advance. Thereafter, the user is able to request the home control gateway 20 for accessing the operating interface by using the class C network uniform resource locator containing the identity code. Specifically, a process of storing the phone number into the home control gateway 20 includes the following steps. First of all, the user presses the learning button 212 and the reset button 214 disposed on the home control gateway 20 at the same time. Next, the reset button 214 is released but the learning button 212 is continually pressed. At the time, a learning function of the home control gateway 20 is activated. Thereafter, during a period in which the learning button 212 is not released, the user may make a phone call to the home control gateway 20 by using the mobile communication device 40. In this case, the home control gateway 20 may identify the phone number of such phone call according to a calling signal and storing the phone number of the phone call into the home control gateway 20 without answering the phone call. Secondly, the home control gateway 20 generates the identity code according to the phone number, and transfers the short message containing the identity code to the mobile communication device 40 of the user through the mobile phone network 50. Then, the mobile communication device 40 of the user may request the home control gateway 20 for accessing the operating interface through the local area network 30 by using the class C network uniform resource locator containing such identity code.

For example, hereinafter, it is assumed that the user intends to open a door lock through the operating interface of the home control gateway 20. First of all, the user must have the phone number recorded by the home control gateway 20 through the learning function. Therefore, the user can obtain the identity code (e.g., the identity code is “AZKKAKKAKK”) through the short message. Secondly, the user may log in the wireless local area network (e.g., class C network 192.168.1.x) provided by the home control gateway 20 through the local area network 30 by using the mobile communication device 40. Subsequently, the user may input the class C network uniform resource locator containing the identity code (e.g., “http://192.168.1.1/AZKKAKKAKK”) and provided by the home control gateway 20 into an address bar of the browser of the mobile communication device 40 in order to request the home control gateway 20 for accessing the operating interface. The home control gateway 20 may then transfer a frame of a control web page in packets to the mobile communication device 40 through the local area network 30 to be displayed by the browser. Therefore, the user may then open the door lock through a mechanism on the control page. For example, the user may click on a control button “unlock the door” in the web page to transmit this control command in packets back to the home control gateway 20. Then, the home control gateway 20 unlocks the door lock, and the user is thus accomplished the purpose of unlocking the door lock.

In an exemplary embodiment, the gateway management module 206 has a mapping table. The mapping table includes a plurality of characters or symbols, and the characters and symbols are corresponding to a plurality of numbers. The gateway management module 206 generates the identity code by searching for the corresponding characters or symbols according to the mapping table.

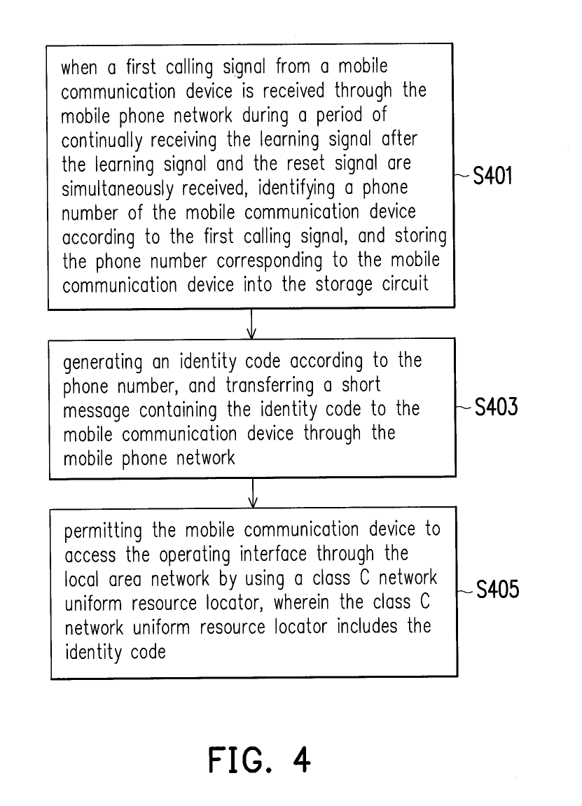

FIG. 3 is a flowchart illustrating a mapping table in the gateway control method according to an exemplary embodiment.

Referring to FIG. 3, the numbers are corresponding to the characters (or symbols) in the mapping table includes, such that the identity code may be generated by searching the mapping table. For instance, by searching the mapping table for the phone number “0988188188”, the identity code with a string “AZKKAKKAKK” may be generated. Accordingly, the user is able to request the home control gateway 20 for accessing the operating interface by using the class C network uniform resource locator containing the identity code, so as to control the home equipments. In addition, in an exemplary embodiment, a hash function may also be utilized to generate the identity code. However, the invention is not limited thereto. It is worth mentioning that, the generated identity code is unique, and stored in the home control gateway 20 together with the corresponding phone number.

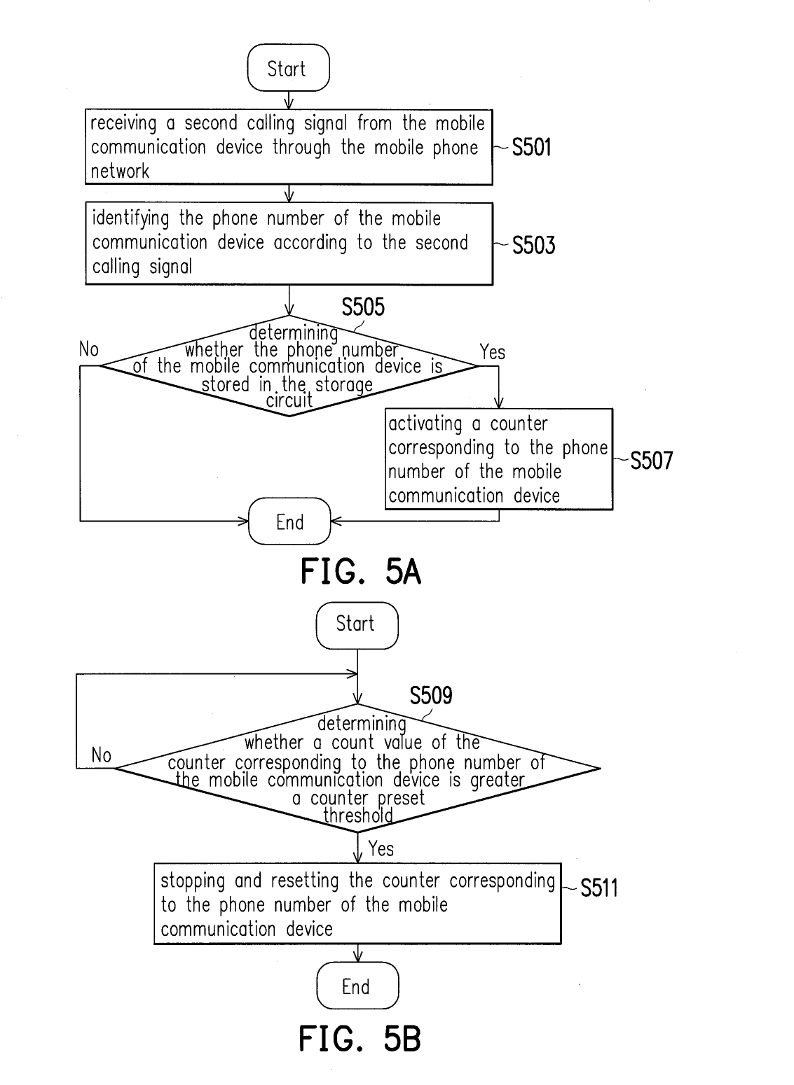

FIG. 4 is a flowchart illustrating a gateway connection method according to an exemplary embodiment.

Referring to FIG. 4, in step S401, after the learning signal from the learning button 212 and the reset signal from the reset button 214 are simultaneously received by the gateway management module 206 and during a period of continually receiving the learning signal from the learning button 212, when the first communication circuit 208 receives the calling signal from the mobile communication device 40 through the mobile phone network 50, the gateway management module 206 identifies the phone number of the mobile communication device 40 according to this calling signal and stores the phone number corresponding to the mobile communication device 40 into the storage circuit 204.

In step S403, the gateway management module 206 generates the identity code according to the phone number corresponding to the mobile communication device 40, and the first communication circuit 208 transfers the short message containing the identity code to the mobile communication device 40 through the mobile phone network 50.

In step S405, the gateway management module 206 permits the mobile communication device 40 to access the operating interface through the local area network 30 by using a class C network uniform resource locator. Therein, the class C network uniform resource locator includes the identity code.

Further, in another exemplary embodiment, after the user has stored the phone number and obtained the identity code through the learning function of the home control gateway 20, when the user intends to perform home control (e.g., unlocking the door) through the home control gateway 20, the user must first make a phone call to the home control gateway 20. The home control gateway 20 will not answer the incoming call but identify whether the phone number of the incoming call exists in the home control gateway 20 instead. When the home control gateway 20 confirms that the phone number of the user already exists, a counter corresponding to the phone number is then activated. Particularly, in this exemplary embodiment, a count value of the counter corresponding to the phone number is compared with a counter preset threshold being pre-defined. When the count value of the counter corresponding to the phone number of the mobile communication device is greater than the counter preset threshold, the counter corresponding to the phone number of the mobile communication device is stopped and reset. For example, assuming that the counter preset threshold is set to 5 minutes, if the count value of the counter corresponding to the phone number of the mobile communication device has been counted over 5 minutes, the counter corresponding to the phone number of the mobile communication device is stopped and the counter is then reset. In addition, the user must request the home control gateway 20 for accessing the operating interface by using the class C network uniform resource locator containing the identity code corresponding to the phone number within a time period defined by the counter preset threshold such that the accessing can be can be permitted. Specifically, the user must first use the mobile communication device 40 to make the phone call to the home control gateway 20 to activate the counter, and transfer the request with the class C network uniform resource locator containing the identity code corresponding to the phone number within to the home control gateway 20 within the limited time such that the home control gateway 20 can permit the mobile communication device 40 to access the operating interface.

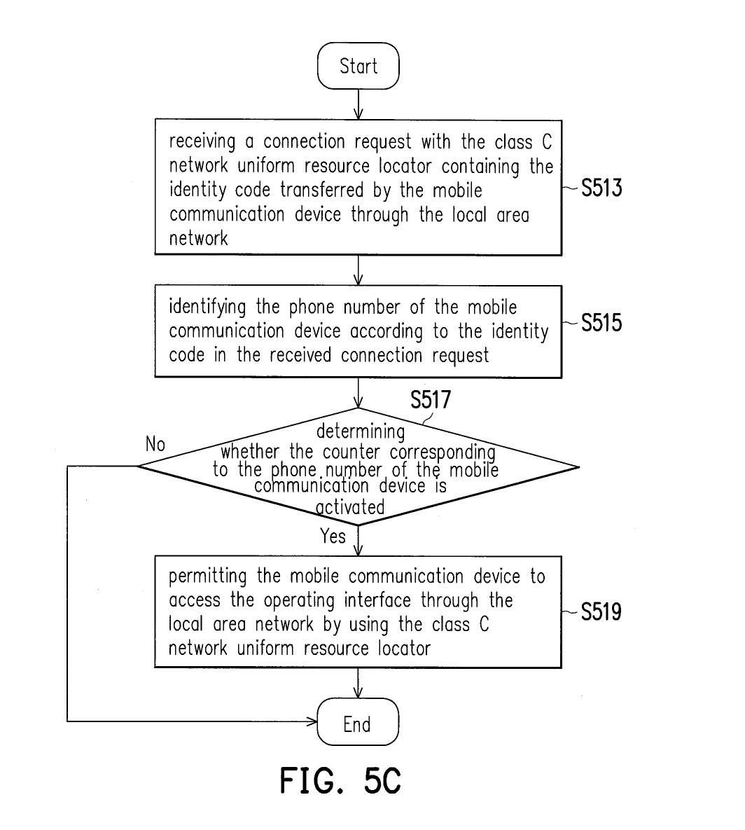

FIG. 5A, FIG. 5B and FIG. 5C are flowcharts illustrating a gateway connection method according to another exemplary embodiment of the invention.

Referring to FIG. 5A, first, in step S501, the first communication circuit 208 receives a second calling signal from the mobile communication device 40 through the mobile phone network 50.

In step S503, the gateway management module 206 identifies the phone number of the mobile communication device 40 according to the second calling signal.

In step S505, the gateway management module 206 determines whether the phone number of the mobile communication device 40 exists in the storage circuit 204.

If the phone number of the mobile communication device 40 exists in the storage circuit 204, in step S07, the gateway management module 206 activates a counter corresponding to the phone number of the mobile communication device 40.

Referring to FIG. 5B, in step S09, the gate management module 206 continues to determine whether a count value of the counter corresponding to the phone number of the mobile communication device 40 is greater a counter preset threshold.

When the count value of the counter corresponding to the phone number of the mobile communication device 40 is greater than the counter preset threshold, in step S511 the gateway management module 206 stops and resets the counter corresponding to the phone number of the mobile communication device 40.

Referring to FIG. 5C, the second communication circuit 210 receives a connection request with the class C network uniform resource locator containing the identity code transferred by the mobile communication device 40 through the local area network 30.

In step S515, the gateway management module 206 identifies the phone number of the mobile communication device 40 according to the identity code in the received connection request. Specifically, the gateway management module 206 searches and obtains the phone number corresponding to the received identity code from the storage module 204. In another exemplary embodiment, if the gateway management module 206 cannot locate a corresponding phone number in the storage circuit 204 according to the identity code in the received connection request, it indicates that the connection request is an insecure connection request. Accordingly, the gateway management module 206 rejects this insecure connection request.

After the phone number of the mobile communication device 40 is obtained through the identity code, in step S517, the gate management module 206 determines whether the counter corresponding to the phone number of the mobile communication device 40 is activated.

If the counter corresponding to the phone number of the mobile communication device 40 is not activated, it indicates that the phone call is not made to the home control gateway 20 by the mobile communication device 40. In this case, the process of FIG. 5C is ended to thereby reject this insecure connection request.

If the counter corresponding to the phone number of the mobile communication device 40 is activated, in step S519, the gateway management module 206 permits the mobile communication device 40 to access the operating interface through the local area network 30 by using the class C network uniform resource locator containing the identity code.

In other words, in the embodiments of FIG. 5A, FIG. 5B and FIG. 5C, the user can only be permitted to access the operating interface by using the class C network uniform resource locator containing the identity code within a preset time after the phone call is made to the home control gateway 20, so as to further ensure security of the connection.

In summary, with the home control gateway and the gateway connection method according the exemplary embodiments of the invention, the machine automatically learns and records the phone numbers so that the users do not have input the phone numbers manually. Accordingly, the phone number of the user is stored in advance, and the identity code corresponding to the phone number can be sent to the user. Therefore, the user is able to request the home control gateway for accessing the operating interface by using the class C network uniform resource locator containing the identity code corresponding to the phone number. As a result, the user is able to operate the household equipments through the mobile communication device in convenient, secure, simple and easy manners.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A home control gateway, comprising:
a microprocessor unit;
a gateway management module coupled to the microprocessor unit, wherein the gateway management module provides an operating interface;
a storage circuit coupled to the microprocessor unit;
a first communication circuit coupled to the microprocessor unit, wherein the first communication circuit is configured to connect to a mobile phone network;
a second communication circuit coupled to the microprocessor unit, wherein the second communication circuit is configured to connect to a local area network;
a learning button coupled to the gateway management module; and
a reset button coupled to the gateway management module,
wherein the gateway management module receives a reset signal when the reset button is enabled, and the gateway management module receives a learning signal when the learning button is enabled,
wherein when the first communication circuit receives a first calling signal from a mobile communication device through the mobile phone network during a period of continually receiving the learning signal after the learning signal and the reset signal are simultaneously received, the gateway management module identifies a phone number of the mobile communication device according to the first calling signal, and stores the phone number corresponding to the mobile communication device into the storage circuit,
wherein the gateway management module generates an identity code according to the phone number,
wherein the first communication circuit transfers a short message containing the identity code to the mobile communication device through the mobile phone network,
wherein the gateway management module permits the mobile communication device to access the operating interface through the local area network by using a class C network uniform resource locator, wherein the class C network uniform resource locator includes the identity code.

2. The home control gateway of claim 1,
wherein the first communication device is further configured to receive a second calling signal from the mobile communication device through the mobile phone network,
wherein the gateway management module identifies the phone number of the mobile communication device according to the second calling signal and determines whether the phone number of the mobile communication device exists in the storage circuit,
wherein the gateway management module activates a counter corresponding to the phone number of the mobile communication device when the phone number of the mobile communication device exists in the storage circuit.

3. The home control gateway of claim 2,
wherein the gateway management module stops and resets the counter corresponding to the phone number of the mobile communication device when a count value of the counter corresponding to the phone number of the mobile communication device is greater than a counter preset threshold.

4. The home control gateway of claim 2,
wherein the gateway management module permits the mobile communication device to access the operating interface through the local area network by using the class C network uniform resource locator only when the counter corresponding to the phone number of the mobile communication device is activated and the count value of the counter corresponding to the phone number of the mobile communication device is not greater than the counter preset threshold.

5. The home control gateway of claim 1, wherein the gateway management module has a mapping table including a plurality of characters or symbols, and the characters and symbols are respectively corresponding to a plurality of numbers,
wherein the gateway management module generates the identity code by searching each of numbers in the phone number of the mobile communication device for the corresponding characters or symbols according to the mapping table.

6. A gateway connection method, executed by a home control gateway, wherein the home control gateway provides an operating interface, and the gateway connection method comprises:
connecting to a mobile phone network;
connecting to a local area network;
receiving a learning signal from a learning button;
receiving a reset signal from a reset button;
when a first calling signal from a mobile communication device is received through the mobile phone network during a period of continually receiving the learning signal after the learning signal and the reset signal are simultaneously received, identifying a phone number of the mobile communication device according to the first calling signal, and storing the phone number corresponding to the mobile communication device into a storage circuit;
generating an identity code according to the phone number;
transferring a short message containing the identity code to the mobile communication device through the mobile phone network; and
permitting the mobile communication device to access the operating interface through the local area network by using a class C network uniform resource locator, wherein the class C network uniform resource locator includes the identity code.

7. The gateway connection method of claim 6, further comprising:
receiving a second calling signal from the mobile communication device through the mobile phone network;
identifying the phone number of the mobile communication device according to the second calling signal and determining whether the phone number of the mobile communication device exists in the storage circuit; and
activating a counter corresponding to the phone number of the mobile communication device when the phone number of the mobile communication device exists in the storage circuit.

8. The gateway connection method of claim 7, further comprising:
stopping and resetting the counter corresponding to the phone number of the mobile communication device when a count value of the counter corresponding to the phone number of the mobile communication device is greater than a counter preset threshold.

9. The gateway connection method of claim 7, further comprising:
permitting the mobile communication device to access the operating interface through the local area network by using the class C network uniform resource locator only when the counter corresponding to the phone number of the mobile communication device is activated and the count value of the counter corresponding to the phone number of the mobile communication device is not greater than the counter preset threshold.

10. The gateway connection method of claim 6, wherein the home control gateway has a mapping table including a plurality of characters or symbols, and the characters and symbols are corresponding to a plurality of numbers,
wherein the step of generating the identity code according to the phone number comprises:
generating the identity code by searching each of numbers in the phone number of the mobile communication device for the corresponding characters or symbols according to the mapping table.
